(19) United States
(12) Patent Application Publication
(10) Pub. No.: US 2024/0297513 A1
(43) Pub. Date: Sep. 5, 2024

(54) POWER TOOL INCLUDING SOLID-STATE PROTECTION CIRCUIT

(71) Applicant: MILWAUKEE ELECTRIC TOOL CORPORATION, Brookfield, WI (US)

(72) Inventors: Benjamin R. Suhr, Milwaukee, WI (US); Douglas R. Fieldbinder, Greendale, WI (US)

(21) Appl. No.: 18/591,200

(22) Filed: Feb. 29, 2024

Related U.S. Application Data
(60) Provisional application No. 63/488,094, filed on Mar. 2, 2023.

(51) Int. Cl. H02J 7/00

(52) U.S. Cl. CPC H02J 7/0031; H02J 7/00304; H02J 2310/22

(57) ABSTRACT

A power tool including a housing, a motor supported by the housing, a battery pack interface configured to receive a battery pack, a switching module for selectively providing power from the battery pack to the motor, and a solid-state protection circuit. The solid-state protection circuit includes a switch configured to control current provided to the motor, and a current measurement device configured to determine a level of current supplied to the switch, and output a first signal related to the level of current supplied to the switch. The solid-state protection circuit also includes a gate driver electrically connected to the switch. The gate driver is configured to receive a control signal to disable the switch in response to the first signal indicating that the level of current supplied to the switch exceeding a current threshold.

### RELATED APPLICATIONS

This application claims the benefit of U.S. Provisional Patent Application No. 63/488,094, filed Mar. 2, 2023, the entire content of which is herein incorporated by reference.

### FIELD

Embodiments described herein relate to power tools.

### SUMMARY

Power tools described herein include a housing, a motor supported by the housing, a battery pack interface configured to receive a battery pack, a switch configured to control current provided from the battery pack interface to the motor, and a solid-state protection circuit. The solid-state protection circuit includes a current measurement device configured to determine a level of current supplied to the switch and output a first signal related to the level of current supplied to the switch, and a gate driver electrically connected to the switch. The gate driver is configured to receive a control signal to disable the switch in response to the first signal indicating that the level of current supplied to the switch exceeds a current threshold.

In some aspects, the solid-state protection circuit further includes a controller configured to receive the first signal from the current measurement device, determine, based on the first signal, whether the level of current supplied to the switch exceeds the current threshold, measure a duration of time that the level of current supplied to the switch exceeds the current threshold, determine whether the duration of time exceeds a time limit, and generate, in response to determining that the duration of time exceeds the time limit, the control signal to disable the switch.

In some aspects, the controller is further configured to determine whether the level of current supplied to the switch exceeds a particular one of a plurality of current thresholds, and determine the time limit based on the particular one of the plurality of current thresholds that the current supplied to the switch exceeds.

In some aspects, the solid-state protection circuit further includes a resistive-capacitive circuit configured to receive the first signal related to the level of current supplied to the switch, and a comparator configured to receive, from the resistive-capacitive circuit, a second signal related to a voltage output of the resistive-capacitive circuit, receive a third signal related to a voltage threshold, and generate the control signal in response to the second signal being greater than the third signal.

In some aspects, the solid-state protection circuit further includes a voltage divider circuit. The voltage threshold is set using the voltage divider circuit, and the voltage threshold is based on the current threshold.

In some aspects, the solid-state protection circuit includes a pulse-width modulation (“PWM”) driver circuit configured to modulate the first signal to have a duty cycle proportional to the level of current supplied to the switch, and output the modulated first signal to the resistive-capacitive circuit.

In some aspects, the current measurement device is configured to determine the level of current supplied to the switch by measuring a voltage drop across the switch.

In some aspects, the solid-state protection circuit further includes a sense resistor connected in series with the switch, and the current measurement device is configured to determine the level of current supplied to the switch by measuring a voltage drop across the sense resistor.

Methods for controlling a power tool having a motor, a battery pack interface, and a switch configured to control current provided from the battery pack interface to the motor described herein include determining, with a current measurement device, a level of current supplied to the switch, outputting, with the current measurement device, a first signal related to the level of current supplied to the switch, and receiving, with a gate driver electrically connected to the switch, a control signal to disable the switch in response to the first signal indicating that the level of current supplied to the switch exceeds a current threshold.

In some aspects, the method further includes receiving, with a controller, the first signal from the current measurement device, determining, with the controller based on the first signal, whether the level of current supplied to the switch exceeds the current threshold, measuring, with the controller, a duration of time that the level of current supplied to the switch exceeds the current threshold, determining, with the controller, whether the duration of time exceeds a time limit, and generating, with the controller in response to determining that the duration of time exceeds the time limit, the control signal to disable the switch.

In some aspects, the method further includes determining, with the controller, whether the level of current supplied to the switch exceeds a particular one of a plurality of current thresholds, and determining the time limit based on the particular one of the plurality current thresholds that the current supplied to the switch exceeds.

In some aspects, the method further includes receiving, with a resistive-capacitive circuit electrically connected to the current measurement device, the first signal related to the level of current supplied to the switch, receiving, with a comparator electrically connected to the resistive-capacitive circuit and the gate driver, a second signal related to a voltage output of the resistive-capacitive circuit, receiving, with the comparator, a third signal related to a voltage threshold, and generating, with the comparator, the control signal in response to the second signal being greater than the third signal.

In some aspects, the voltage threshold is set using a voltage divider circuit electrically connected to the comparator, and the voltage threshold is based on the current threshold.

In some aspects, the method further includes receiving, with a pulse-width modulation (“PWM”) driver circuit electrically connected to the current measurement device and the resistive-capacitive circuit, the first signal from the current measurement device, modulating, with the PWM driver circuit, the first signal to have a duty cycle proportional to the level of current supplied to the switch, and outputting, with the PWM driver circuit, the modulated first signal to the resistive-capacitive circuit.

In some aspects, determining the level of current supplied to the switch includes measuring a voltage drop across the switch.

In some aspects determining the level of current supplied to the switch includes measuring a voltage drop across a sense resistor connected in series with the switch.

Power tools described herein include a motor, a power input interface electrically connectable to a power source, a switch arranged on a current path between the power input interface and the motor, and a solid-state protection circuit. The solid-state protection circuit includes a current measurement device configured to determine a level of current on the current path and output a first signal related to the level of current on the current path, and a gate driver electrically connected to the switch. The gate driver is configured to receive a control signal to disable the switch in response to the first signal indicating that the level of current on the current path exceeds a current threshold.

In some aspects, the solid-state protection circuit further includes a controller configured to receive the first signal from the current measurement device, determine, based on the first signal, whether the level of current on the current path exceeds the current threshold, measure a duration of time that the level of current supplied to the switch exceeds the current threshold, determine whether the duration of time exceeds a time limit, and generate, in response to determining that the duration of time exceeds the time limit, the control signal to disable the switch.

In some aspects, the controller is further configured to determine whether the level of current on the current path exceeds a particular one of a plurality of current thresholds, and determine the time limit based on the particular one of the plurality of current thresholds that the current supplied to the switch exceeds.

In some aspects, the solid-state protection circuit further includes a resistive-capacitive circuit configured to receive the first signal related to the level of current on the current path, and a comparator configured to receive, from the resistive-capacitive circuit, a second signal related to a voltage output of the resistive-capacitive circuit, receive a third signal related to a voltage threshold, and generate the control signal in response to the second signal being greater than the third signal.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIG. 1 illustrates a power tool, according to some embodiments.

FIG. 2 illustrates a control system for a power tool, according to some embodiments.

FIG. 3 is a schematic diagram of a solid-state protection circuit, according to some embodiments.

FIG. 4 illustrates an overcurrent protection method, according to some embodiments.

FIG. 5 is a schematic diagram of a solid-state protection circuit, according to some embodiments.

FIG. 6 illustrates an overcurrent protection method, according to some embodiments.

FIG. 7 is a schematic diagram of a solid-state protection circuit, according to some embodiments.

FIG. 8 illustrates an overcurrent protection method, according to some embodiments.

### DETAILED DESCRIPTION

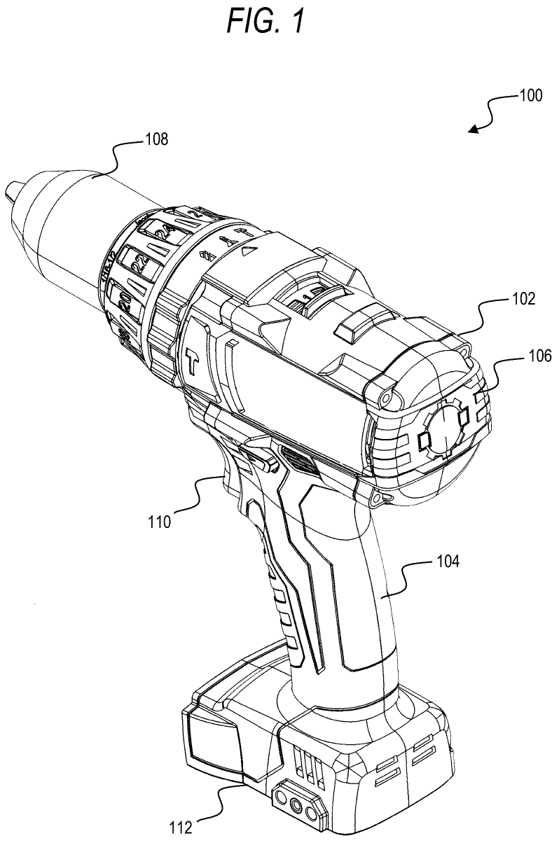

FIG. 1 illustrates a power tool 100 including a brushless direct current (“BLDC”) motor. The power tool 100 is, for example, a brushless hammer drill including a housing 102. The housing 102 includes a handle portion 104 and motor housing portion 106. The power tool 100 further includes an output driver 108 (illustrated as a chuck), a trigger 110, and a power input interface 112 (e.g., battery pack interface 112). The power input interface 112 is configured to mechanically and electrically connect to a power source, such as, for example, a power tool battery pack. Although FIG. 1 illustrates a hammer drill, in some embodiments, the components described herein are incorporated into other types of power tools including drill-drivers, impact drivers, impact wrenches, angle grinders, circular saws, reciprocating saws, string trimmers, leaf blowers, vacuums, and the like. In a brushless motor power tool, such as power tool 100, switching elements are selectively enabled and disabled by control signals from a controller to selectively apply power from a power source (e.g., battery pack, a portable power supply, etc.) to drive a brushless motor.

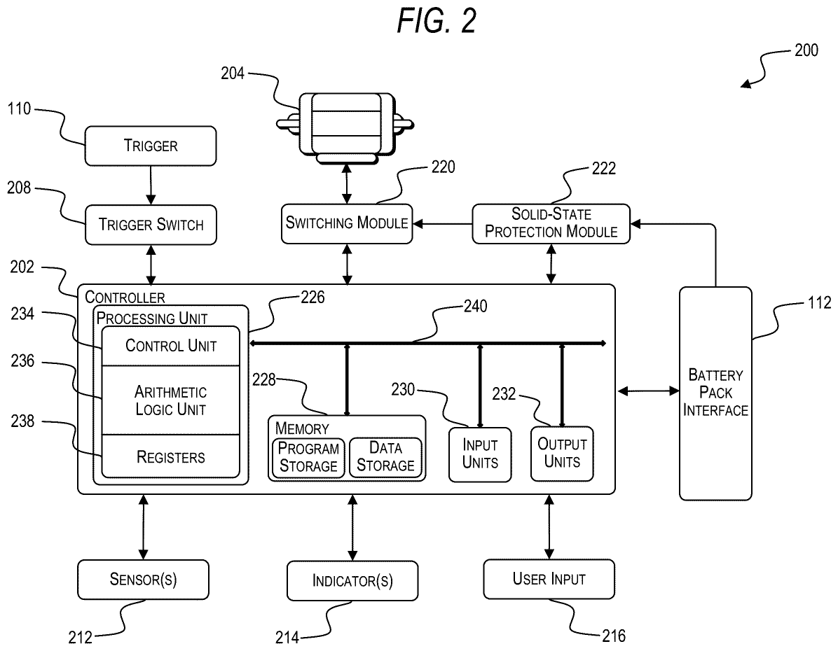

FIG. 2 illustrates a control system 200 for the power tool 100 that includes a solid-state protection system (e.g., a short circuit detection system). The control system 200 includes a controller 202 (e.g., a primary controller). The controller 202 is electrically and/or communicatively connected to a variety of modules or components of the power tool 100. For example, the illustrated controller 202 is electrically connected to a motor 204 supported by the housing 102, the battery pack interface 112, a trigger switch 208 (connected to the trigger 110), one or more sensors 212 (also referred to as sensing circuits), one or more indicators 214, a user input module 216, an inverter or a switching module 220 (e.g., including a plurality of switching FETs). The controller 202 includes combinations of hardware and software that are operable to, among other things, control the operation of the power tool 100, monitor the operation of the power tool 100, activate the one or more indicators 214 (e.g., an LED), etc. A solid-state protection module 222 is connected to the controller 202 and the FET switching module 220. In some embodiments, the sensors 212 measure or detect a current in the inverter or switching module 220 (e.g., a current of one or more phases of the inverter).

The controller 202 includes a plurality of electrical and electronic components that provide power, operational control, and protection to the components and modules within the controller 202 and/or the power tool 100. For example, the controller 202 includes, among other things, a processing unit 226 (e.g., a microprocessor, a microcontroller, an electronic controller, an electronic processor, or another suitable programmable device), a memory 228, input units 230, and output units 232. The processing unit 226 includes, among other things, a control unit 234, an arithmetic logic unit (“ALU”) 236, and a plurality of registers 238, and is implemented using a known computer architecture (e.g., a modified Harvard architecture, a von Neumann architecture, etc.). The processing unit 226, the memory 228, the input units 230, and the output units 232, as well as the various modules or circuits connected to the controller 202 are connected by one or more control and/or data buses (e.g., common bus 240). The control and/or data buses are shown generally in FIG. 2 for illustrative purposes. The use of one or more control and/or data buses for the interconnection between and communication among the various modules, circuits, and components would be known to a person skilled in the art in view of the invention described herein.

The memory 228 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 226 is connected to the memory 228 and executes software instructions that are capable of being stored in a RAM of the memory 228 (e.g., during execution), a ROM of the memory 228 (e.g., on a generally permanent basis), or another non-transitory computer readable medium such as another memory or a disc. Software included in the implementation of the power tool 100 can be stored in the memory 228 of the controller 202. The software includes, for example, firmware, one or more applications, program data, filters, rules, one or more program modules, and other executable instructions. The controller 202 is configured to retrieve from the memory 228 and execute, among other things, instructions related to the control processes and methods described herein. In other constructions, the controller 202 includes additional, fewer, or different components.

The battery pack interface 112 includes a combination of mechanical components (e.g., rails, grooves, latches, etc.) and electrical components (e.g., one or more terminals) configured to and operable for interfacing (e.g., mechanically, electrically, and communicatively connecting) with a battery pack. The battery pack interface 112 supplies power to the FET switching module 220 to be switched by the switching FETs to selectively provide power to the motor 204. In some embodiments, the solid-state protection module 222 is connected between the battery pack interface 112 and the switching module 220. In some embodiments, the solid-state protection module is additionally or alternatively provided at a different location within the power tool 100. The solid-state protection module 222 can be associated with, for example, any switch (e.g., FET) included within the power tool 100. The power tool 100 can include a plurality of solid-state protection modules 222, and a single solid-state protection module 222 is shown in FIG. 2 for illustrative purposes.

The sensors 212 include one or more current sensors, one or more speed sensors, one or more Hall Effect sensors, one or more temperature sensors, etc. The indicators 214 include, for example, one or more light-emitting diodes (“LEDs”). The indicators 214 can be configured to display conditions of, or information associated with, the power tool 100. For example, the indicators 214 are configured to indicate measured electrical characteristics of the power tool 100, the status of the power tool, the status of the solid-state protection module 222, etc. The user input module 216 is operably coupled to the controller 202 to, for example, select a forward mode of operation or a reverse mode of operation, a torque and/or speed setting for the power tool 100 (e.g., using torque and/or speed switches), etc. In some embodiments, the user input module 216 includes a combination of digital and analog input or output devices required to achieve a desired level of operation for the power tool 100, such as one or more knobs, one or more dials, one or more switches, one or more buttons, etc.

In the embodiment of FIG. 2, the solid-state protection module 222 is electrically connected between the battery pack interface 112 and the FET switching module 220. In some embodiments, the solid-state protection module 222 is also electrically and/or communicatively connected to the controller 202 via a signal line. The solid-state protection module 222 is configured to monitor one or more electrical characteristics of the power tool 100 for conditions that indicate an overcurrent condition. The solid-state protection module 222 may be provided in the power tool 100 in addition to, or as an alternative to, a conventional fuse. In some embodiments, when the solid-state protection module 222 determines that one or more electrical characteristics indicate an overcurrent condition, the solid-state protection module 222 disables a current supplied to, for example, the motor 204 in order to prevent power from being supplied to the motor 204. In some embodiments, the solid-state protection module 222 determines that one or more electrical characteristics indicate an unwanted current, an uncontrolled current, a damaging current, a hazardous current, etc.

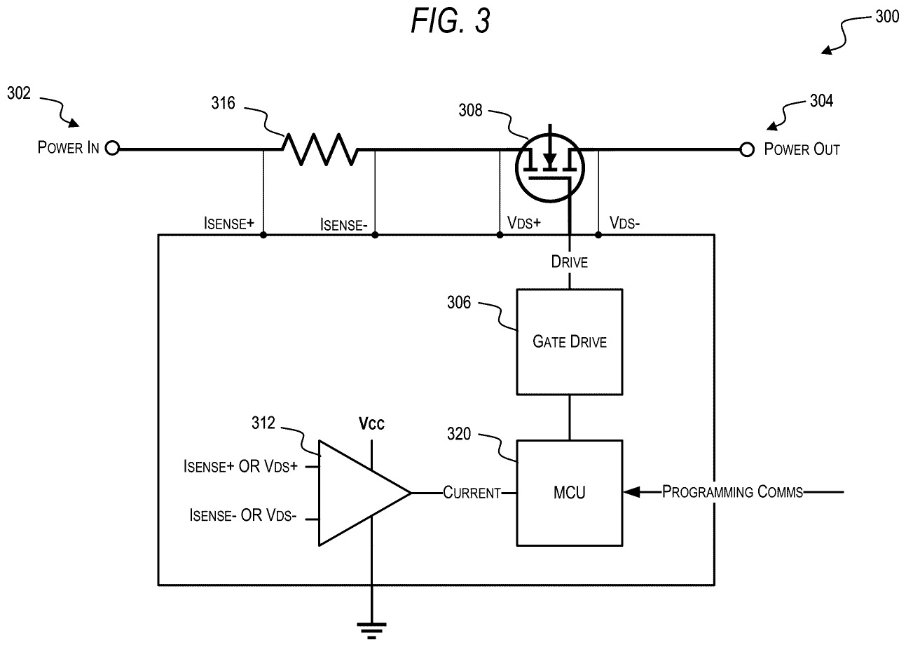

FIG. 3 illustrates a topology of a solid-state protection circuit 300 that can be partially or fully included within the solid-state protection module 222. In some embodiments, the solid-state protection circuit 300 is separate from the controller 202. In other embodiments, the solid-state protection circuit 300 is included as a module within the controller 202. The solid-state protection circuit 300 includes a power input terminal 302 configured to receive input power via, for example, the battery pack interface 112, and a power output terminal 304 configured to output power to, for example, the motor 204. The power input terminal 302 and the power output terminal 304 define a current path for the power tool 100. The solid-state protection circuit 300 includes at least one gate driver 306, and the at least one gate driver 306 is electrically connected to a switch 308 (e.g., a transistor, a FET, a MOSFET, etc.). The solid-state protection circuit 300 monitors the power tool 100 for an excessive current (e.g., a current greater than one or more threshold values, a current greater than a threshold value for a predetermined amount of time, etc.). When an excessive current is detected, the gate driver 306 is configured to disable current supplied through the switch 308 by disabling the switch 308 (e.g., controlling the switch 308 to an open or non-conductive state). Unlike a fuse, which must be replaced after disabling current in a tool, the solid-state protection module 222 may reset the switch 308 to a closed or conductive state when the tool is no longer experiencing the excessive current or a corresponding fault condition.

The solid-state protection circuit 300 includes a current measurement device 312 for determining a level of current supplied to the switch 308 from the power input terminal 302. In some embodiments, the current measurement device 312 determines the level of current supplied to the switch 308 based on a voltage drop across the switch 308. However, in some embodiments, the current measurement device 312 determines the level of current supplied to the switch 308 based on a voltage drop across a sense resistor 316 connected in series with the switch 308, and outputs a signal (e.g., a first signal) related to the level of current supplied to the switch 308. In some embodiments, current can be measured using both the voltage across the current sense resistor 316 and the voltage across the switch 308. In some embodiments, the current measurement device 312 includes an operational amplifier configured to output the first signal based on the measured drop across the sense resistor 316 and/or the switch 308.

Referring still to FIG. 3, the solid-state protection circuit 300 also includes a controller 320 (e.g., a secondary controller) separate from the controller 202 and electrically connected to the current measurement device 312 and the at least one gate driver 306. The controller 320 includes a memory configured to store current threshold and time limit information. In some instances, the memory of the controller 320 stores a lookup table (“LUT”) of a plurality of current threshold values. Each of the plurality of current threshold values corresponds to a time limit indicating a maximum duration of time that the first signal may exceed a particular current threshold. The controller 320 is configured to receive, from the current measurement device 312, the signal related to the level of current supplied to the switch 308 (e.g., the first signal). When the controller 320 determines that the first signal has exceeded a particular current threshold for the corresponding time limit associated with that particular current threshold, the controller 320 generates a control signal for controlling the at least one gate driver 306 to disable current supplied through the switch 308 by disabling the switch 308. For example, the controller 320 may generate a control signal for disabling the current supplied to the motor 204 in response to determining that a level of current in the tool 100 is at 200% of the rated current of the tool 100 for at least five seconds. The controller 320 may also generate a control signal for disabling the current supplied to the motor 204 in response to determining that level of current in the tool 100 is at 300% of the rated current of the tool 100 for at least one second. Various other levels of current and durations can be used to increase the level of control of the switch 308. In some embodiments, the controller 320 can determine a slope between current measurements to determine how quickly the current is changing. In such embodiments, the slope between current measurements can be compared to a rate of change threshold for current.

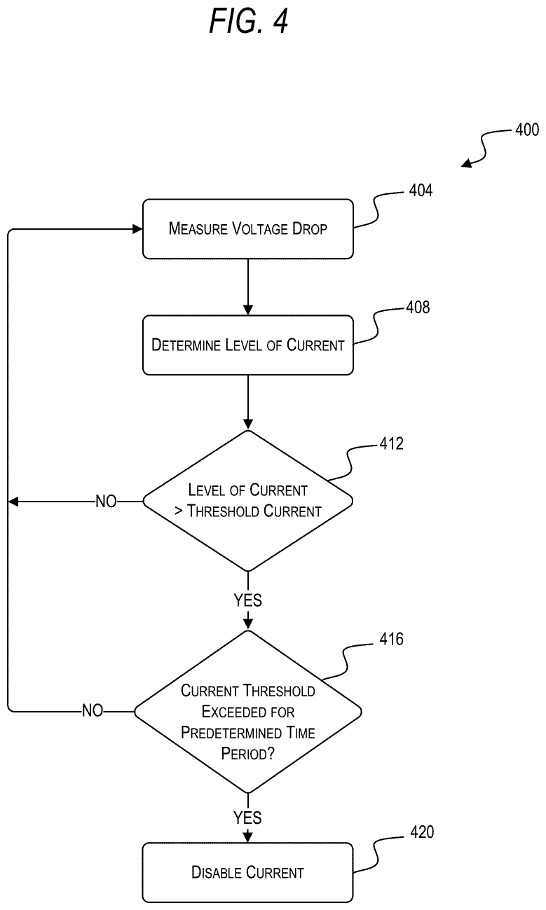

FIG. 4 is a flowchart illustrating a method 400 executed by the solid-state protection circuit 300 during operation of the power tool 100. The method 400 includes measuring, with the current measurement device 312, a voltage drop across one or both of the switch 308 and the sense resistor 316 (STEP 404). Based on the measured voltage drop, the current measurement device 312 determines the level of current supplied to the switch 308 (STEP 408). The method 400 also includes determining, with the controller 320, whether the level of current exceeds a current threshold (STEP 412). In some instances, determining whether the level of current exceeds a current threshold includes determining whether the level of current exceeds a particular one of a plurality of current thresholds. If the controller 320 determines that the level of current does not exceed a current threshold, the method 400 returns to STEP 404 and the current measurement device 312 continues measuring the voltage drop(s). If at STEP 412, the controller 320 determines that the level of current does exceed one of the plurality of current thresholds, the controller 320 measures a duration of time that the level of current exceeds the current threshold, and determines whether the measured duration of time exceeds a time limit (STEP 416). If the measured duration of time does not exceed the time limit, the method 400 returns to STEP 404 and the current measurement device 312 continues measuring the voltage drop. If, at STEP 416, the controller 320 determines the measured duration of time does exceed the time limit, the controller 320 interrupts the current supplied to the FET switching module 220 by outputting a control signal to the at least one gate driver 306 to open, or disable, the switch 308 (STEP 420). In some embodiments, a timer is started when a current threshold is exceeded and continues counting until the current is below the threshold. In some embodiments, the timer is reset any time the current falls below the threshold. However, in some embodiments, the timer can include a delay before being reset in order to filter out transient voltage drops.

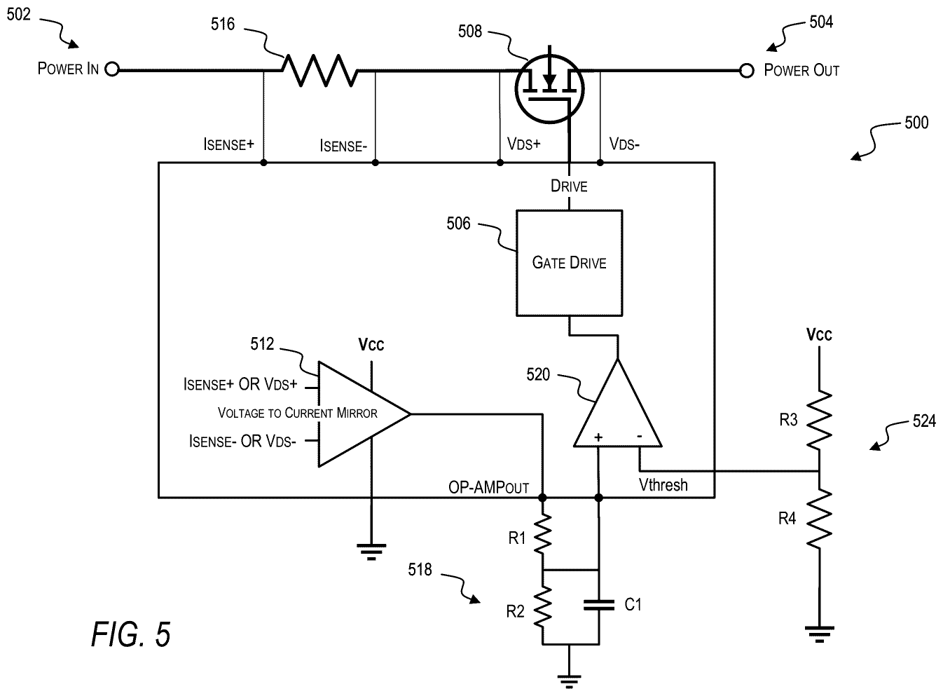

Referring now to FIG. 5, a second topology of a solid-state protection circuit 500 that can be partially or fully included within the solid-state protection module 222 is illustrated. In some embodiments, the solid-state protection circuit 500 is separate from the controller 202. In other embodiments, the solid-state protection circuit 500 is included as a module within the controller 202. As illustrated in FIG. 5, the solid-state protection circuit 500 includes a power input terminal 502, a power output terminal 504, at least one gate driver 506, and a switch 508. The power input terminal 502, the power output terminal 504, the at least one gate driver 506, and the switch 508 are substantially similar to the power input terminal 302, the power output terminal 304, the at least one gate driver 306, and the switch 308, respectively, described above with reference to FIG. 3. In some instances, the solid-state protection circuit 500 also includes a sense resistor 516 that is substantially similar to the sense resistor 316 described above with reference to FIG. 3.

The solid-state protection circuit 500 also includes a current measurement device 512 configured to determine a level of current supplied to the switch 508 based on a measured voltage drop across at least one of the switch 508 and/or the sense resistor 516. In some instances, the current measurement device 512 is configured as a current mirror circuit, and is configured to output a signal (e.g., a first signal) related to the level of current supplied to the switch 508. The solid-state protection circuit 500 further includes a resistive-capacitive (“RC”) circuit 518, a comparator 520, and a voltage divider circuit 524. In the illustrated embodiment, the voltage divider circuit includes a resistor R3 and a resistor R4. The RC circuit 518 is configured to receive the first signal output from the current measurement device 512. In the illustrated example, the RC circuit 518 includes a first resistor R1, a second resistor R2, and a capacitor C1. However, the RC circuit 518 may include more or fewer components than those illustrated in FIG. 5. Aspects and components of the RC circuit 518 may be selected according to a desired rate of charge and discharge of the capacitor C1.

A first input of the comparator 520 is connected to an output of the RC circuit 518. The comparator 520 receives a signal (e.g., a second signal) related to a voltage output of the RC circuit 518 (e.g., a voltage output at the capacitor C1). A second input of the comparator 520 is connected to an output of the voltage divider circuit 524. The comparator 520 receives, from the voltage divider circuit 524, a signal (e.g., a third signal) related to a voltage threshold that is set using the voltage divider circuit 524. In some instances, the voltage threshold is a user-defined voltage threshold. When the second signal output by the RC circuit 518 is greater than the third signal output by the voltage divider circuit 524, the comparator 520 outputs a control signal to the at least one gate driver 506 for disabling the current supplied through the switch 508.

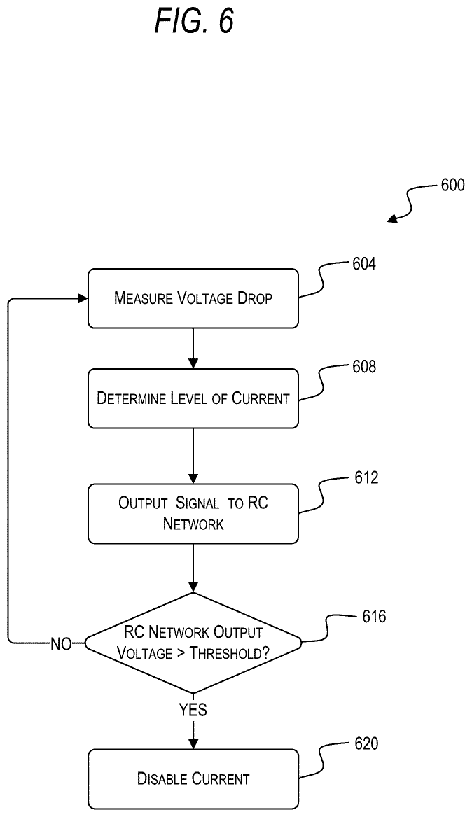

FIG. 6 is a flowchart illustrating a method 600 executed by the solid-state protection circuit 500 during operation of the power tool 100. The method 600 includes measuring, with the current measurement device 512, a voltage drop across one or both of the switch 508 and the sense resistor 516 (STEP 604). Based on the measured voltage drop, the current measurement device 512 determines the level of current supplied to the switch 508 (STEP 608). The method 600 also includes outputting a signal related to the determined level of current to the RC circuit 518 (STEP 612). The method 600 further includes determining, with the comparator 520, whether a signal output by the RC circuit 518 is greater than a signal related to a voltage threshold (STEP 616). If the comparator 520 determines that the signal output by the RC circuit 518 is not greater than the signal related to a voltage threshold, the method 600 returns to STEP 604. If, at STEP 616, the comparator 520 determines that the signal output by the RC circuit 518 is greater than the signal related to the voltage threshold, the comparator 520 outputs a control signal to the at least one gate driver 506 for controlling the at least one gate driver 506 to disable current through the switch 508 (e.g., to the motor 204) (STEP 620).

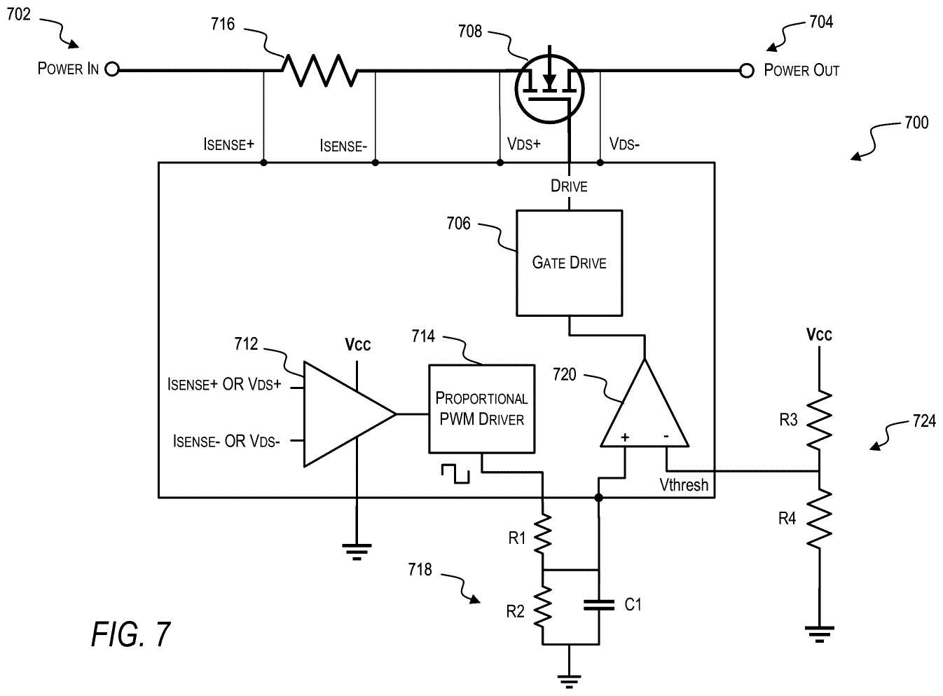

Referring now to FIG. 7, a third topology of a solid-state protection circuit 700 that can be partially or fully included within the solid-state protection module 222 is illustrated. In some embodiments, the solid-state protection circuit 700 is separate from the controller 202. In other embodiments, the solid-state protection circuit 700 is included as a module within the controller 202. As illustrated in FIG. 7, the solid-state protection circuit 700 includes a power input terminal 702, a power output terminal 704, at least one gate driver 706, and a switch 708. The power input terminal 702, the power output terminal 704, at least one gate driver 706, and the switch 708 are substantially similar to the power input terminal 502, the power output terminal 504, the at least one gate driver 506, and the switch 508, respectively, described above with reference to FIG. 5. In some instances, the solid-state protection circuit 700 also includes a sense resistor 716 substantially similar to the sense resistor 516 described above with reference to FIG. 5.

The solid-state protection circuit 700 also includes a current measurement device 712, a pulse-width modulation (“PWM”) driver circuit 714, a RC circuit 718, a comparator 720, and a voltage divider circuit 724. The current measurement device 712 is configured to determine a level of current supplied to the switch 708 based on a measured voltage drop across at least one of the switch 708 or the sense resistor 716. The current measurement device 712 includes, for example, an operational amplifier configured to output a signal (e.g., a first signal) related to the level of current supplied to the switch 708. The PWM driver circuit 714 receives the first signal from the current measurement device 712, modulates the first signal to be proportional to the level of current supplied to the switch, and outputs the modulated signal to an input of the RC circuit 718. In other words, the PWM driver circuit 714 is configured to generate a signal (e.g., a second signal) having a duty cycle proportional to the signal related to the level of current (e.g., the first signal).

The RC circuit 718 may include a first resistor R1, a second resistor R2, and a capacitor C1. However, the RC circuit 718 may include more or fewer components than those illustrated. Aspects and components of the RC circuit 718 may be selected according to a desired rate of charge and discharge of the capacitor C1. The RC circuit 718 receives the modulated signal (e.g., the second signal) from the PWM driver circuit 714, and outputs a third signal to a first input of the comparator 720. The third signal is a signal related to a voltage output of the RC circuit 718 (e.g., a voltage output at the capacitor C1).

A second input of the comparator 720 is connected to an output of the voltage divider circuit 724. In the illustrated embodiment, the voltage divider includes a resistor R3 and a resistor R4. The comparator 720 receives, from the voltage divider circuit 724, a signal (e.g., a fourth signal) related to a voltage threshold that is set using the voltage divider circuit 724. In some instances, the voltage threshold is a user-defined voltage threshold. When the third signal output by the RC circuit 718 is greater than the fourth signal output by the voltage divider circuit 724, the comparator 720 outputs a control signal to the at least one gate driver 706 for disabling the current supplied through the switch 308 (e.g., to the motor 204).

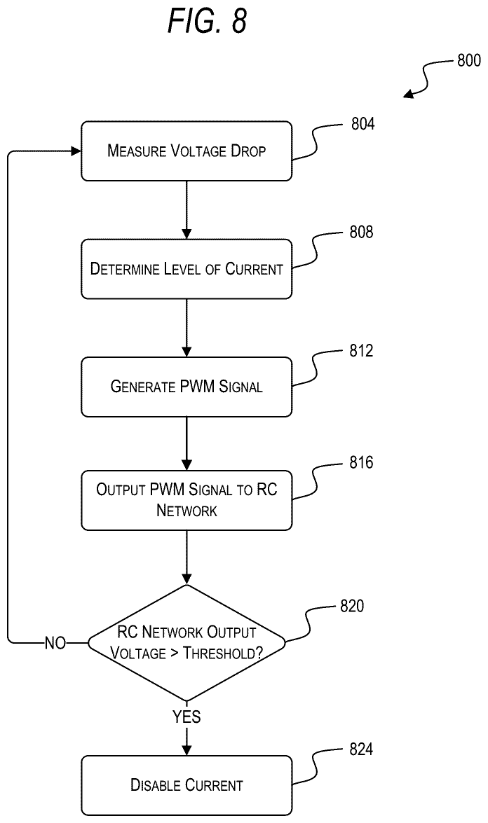

FIG. 8 is a flowchart illustrating a method 800 executed by the solid-state protection circuit 700 during operation of the power tool 100. The method 800 includes measuring, with the current measurement device 712, a voltage drop across one or both of the switch 708 and the sense resistor 716 (STEP 604). Based on the measured voltage drop, the current measurement device 712 determines the level of current supplied to the switch 708 (STEP 808). The method 800 also includes generating, with the PWM driver circuit 714, a PWM signal having a duty cycle proportional to the determined level of current (STEP 812). The PWM driver circuit 714 outputs the PWM signal to the RC circuit 718 (STEP 816). The method 800 further includes determining, with the comparator 720, whether a voltage signal output by the RC circuit 718 is greater than a voltage signal related to a voltage threshold (STEP 820). If the comparator 720 determines that the signal output by the RC circuit 718 is not greater than the signal related to a voltage threshold, the method 800 returns to STEP 804. If, at STEP 820, the comparator 720 determines that the signal output by the RC circuit 718 is greater than the signal related to the voltage threshold, the comparator 720 outputs a control signal to the at least one gate driver 706 for controlling the at least one gate driver 706 to disable current supplied through the switch 708 (e.g., to the motor 204) (STEP 824).

Although aspects of the present disclosure have been described in detail with reference to certain embodiments, variations and modifications exist within the scope and spirit of one or more independent aspects as described. Various features of the disclosure are set forth in the following claims.

What is claimed is:

1. A power tool comprising:
a housing;
a motor supported by the housing;
a battery pack interface configured to receive a battery pack;
a switch configured to control current provided from the battery pack interface to the motor; and
a solid-state protection circuit including:
a current measurement device configured to:
determine a level of current supplied to the switch, and
output a first signal related to the level of current supplied to the switch, and
a gate driver electrically connected to the switch, the gate driver configured to receive a control signal to disable the switch in response to the first signal indicating that the level of current supplied to the switch exceeds a current threshold.

2. The power tool of claim 1, wherein the solid-state protection circuit further includes a controller configured to:
receive the first signal from the current measurement device;
determine, based on the first signal, whether the level of current supplied to the switch exceeds the current threshold;
measure a duration of time that the level of current supplied to the switch exceeds the current threshold;
determine whether the duration of time exceeds a time limit; and
generate, in response to determining that the duration of time exceeds the time limit, the control signal to disable the switch.

3. The power tool of claim 2, wherein the controller is further configured to:
determine whether the level of current supplied to the switch exceeds a particular one of a plurality of current thresholds; and
determine the time limit based on the particular one of the plurality of current thresholds that the current supplied to the switch exceeds.

4. The power tool of claim 1, wherein the solid-state protection circuit further includes:
a resistive-capacitive circuit configured to receive the first signal related to the level of current supplied to the switch; and
a comparator configured to:
receive, from the resistive-capacitive circuit, a second signal related to a voltage output of the resistive-capacitive circuit,
receive a third signal related to a voltage threshold, and
generate the control signal in response to the second signal being greater than the third signal.

5. The power tool of claim 4, wherein:
the solid-state protection circuit further includes a voltage divider circuit;
the voltage threshold is set using the voltage divider circuit; and
the voltage threshold is based on the current threshold.

6. The power tool of claim 4, wherein the solid-state protection circuit includes a pulse-width modulation (“PWM”) driver circuit configured to:
modulate the first signal to have a duty cycle proportional to the level of current supplied to the switch; and
output the modulated first signal to the resistive-capacitive circuit.

7. The power tool of claim 1, wherein the current measurement device is configured to determine the level of current supplied to the switch by measuring a voltage drop across the switch.

8. The power tool of claim 1, wherein:
the solid-state protection circuit further includes a sense resistor connected in series with the switch; and
the current measurement device is configured to determine the level of current supplied to the switch by measuring a voltage drop across the sense resistor.

9. A method for controlling a power tool having a motor, a battery pack interface, and a switch configured to control current provided from the battery pack interface to the motor, the method comprising:
determining, with a current measurement device, a level of current supplied to the switch;
outputting, with the current measurement device, a first signal related to the level of current supplied to the switch; and
receiving, with a gate driver electrically connected to the switch, a control signal to disable the switch in response to the first signal indicating that the level of current supplied to the switch exceeds a current threshold.

10. The method of claim 9, further comprising:
receiving, with a controller, the first signal from the current measurement device;
determining, with the controller based on the first signal, whether the level of current supplied to the switch exceeds the current threshold;
measuring, with the controller, a duration of time that the level of current supplied to the switch exceeds the current threshold;
determining, with the controller, whether the duration of time exceeds a time limit; and
generating, with the controller in response to determining that the duration of time exceeds the time limit, the control signal to disable the switch.

11. The method of claim 10, further comprising:
determining, with the controller, whether the level of current supplied to the switch exceeds a particular one of a plurality of current thresholds; and
determining the time limit based on the particular one of the plurality of current thresholds that the current supplied to the switch exceeds.

12. The method of claim 10, further comprising:
receiving, with a resistive-capacitive circuit electrically connected to the current measurement device, the first signal related to the level of current supplied to the switch;
receiving, with a comparator electrically connected to the resistive-capacitive circuit and the gate driver, a second signal related to a voltage output of the resistive-capacitive circuit;
receiving, with the comparator, a third signal related to a voltage threshold; and
generating, with the comparator, the control signal in response to the second signal being greater than the third signal.

13. The method of claim 12, wherein:
the voltage threshold is set using a voltage divider circuit electrically connected to the comparator; and
the voltage threshold is based on the current threshold.

14. The method of claim 12, further comprising:
receiving, with a pulse-width modulation (“PWM”) driver circuit electrically connected to the current measurement device and the resistive-capacitive circuit, the first signal from the current measurement device;
modulating, with the PWM driver circuit, the first signal to have a duty cycle proportional to the level of current supplied to the switch; and
outputting, with the PWM driver circuit, the modulated first signal to the resistive-capacitive circuit.

15. The method of claim 9, wherein determining the level of current supplied to the switch includes measuring a voltage drop across the switch.

16. The method of claim 9, wherein determining the level of current supplied to the switch includes measuring a voltage drop across a sense resistor connected in series with the switch.

17. A power tool comprising:
a motor;
a power input interface electrically connectable to a power source;
a switch arranged on a current path between the power input interface and the motor; and
a solid-state protection circuit including:
a current measurement device configured to:
determine a level of current on the current path, and
output a first signal related to the level of current on the current path, and
a gate driver electrically connected to the switch, the gate driver configured to receive a control signal to disable the switch in response to the first signal indicating that the level of current on the current path exceeds a current threshold.

18. The power tool of claim 17, wherein the solid-state protection circuit further includes a controller configured to:
receive the first signal from the current measurement device;
determine, based on the first signal, whether the level of current on the current path exceeds the current threshold;
measure a duration of time that the level of current supplied to the switch exceeds the current threshold;
determine whether the duration of time exceeds a time limit; and
generate, in response to determining that the duration of time exceeds the time limit, the control signal to disable the switch.

19. The power tool of claim 18, wherein the controller is further configured to:
determine whether the level of current on the current path exceeds a particular one of a plurality of current thresholds; and
determine the time limit based on the particular one of the plurality of current thresholds that the current supplied to the switch exceeds.

20. The power tool of claim 17, wherein the solid-state protection circuit further includes:
a resistive-capacitive circuit configured to receive the first signal related to the level of current on the current path; and
a comparator configured to:
receive, from the resistive-capacitive circuit, a second signal related to a voltage output of the resistive-capacitive circuit,
receive a third signal related to a voltage threshold, and
generate the control signal in response to the second signal being greater than the third signal.
